(19) United States
(12) Patent Application Publication
(10) Pub. No.: US 2006/0055720 A1
(43) Pub. Date: Mar. 16, 2006

(54) Method for intra-swath banding compensation

(76) Inventors: Stephen T. Olson, Lexington, KY (US); Colin G. Maher, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/938,010

(22) Filed: Sep. 10, 2004

(51) Int. Cl. B41J 29/393

(52) U.S. Cl. 347/19

(57) ABSTRACT

A method of intra-swath banding compensation in an imaging apparatus utilizing an ink jet printhead that reciprocates in a main scan direction, the ink jet printhead having a nozzle array with a plurality of nozzles, includes printing with the plurality of nozzles in the main scan direction a pattern of dots representative of the nozzle array; determining a variation in reflectance of the pattern of dots in a direction substantially perpendicular to the main scan direction; and storing in a memory associated with the printhead compensation values associated with each nozzle of the plurality of nozzles that is to be adjusted to correct for the variation in reflectance.

### BACKGROUND OF THE INVENTION

1. Field of the Invention

The present invention relates to an imaging apparatus, and, more particularly, to a method of intra-swath banding compensation in an imaging apparatus, such as an ink jet printer.

2. Description of the Related Art

An imaging apparatus in the form of an ink jet printer typically forms an image on a sheet of print media by ejecting ink from at least one ink jet printhead to place ink dots on the sheet of print media. Such an ink jet printer typically includes a reciprocating printhead carrier that transports one or more ink jet printheads across the sheet of print media along a bidirectional scanning path defining a print zone of the printer. The bi-directional scanning path is oriented parallel to a main scan direction, also commonly referred to as the horizontal direction. During printing on each scan of the printhead carrier, the sheet of print media is held stationary. An indexing mechanism is used to incrementally advance the sheet of print media in a sheet feed direction, also commonly referred to as a sub-scan direction, through the print zone between scans in the main scan direction, or after all data intended to be printed on the sheet of print media at a particular stationary position has been completed.

For a given stationary position of the sheet of print media, printing may take place during unidirectional or bi-directional scans of the printhead carrier. The height of the printhead generally defines a printing swath as ink is deposited on the sheet of print media during a particular scan of the printhead carrier. A printing swath is made of a plurality of printing lines traced along imaginary rasters, the imaginary rasters being spaced apart in the sheet feed direction, e.g., vertically on the printed page. In order to form the pattern of ink drops on the sheet of print media, a rectilinear array, also known as a matrix, of possible pixel, i.e., drop, locations is defined within the printable boundaries of the sheet of print media. The closest possible spacing of ink drops in the main scan direction is typically referred to as the horizontal resolution, and the closest possible spacing of ink drops in the sub-scan direction, i.e., between adjacent rasters, is typically referred to as the vertical resolution.

One type of printing defect that adversely affects print quality in ink jet printing is known as horizontal banding. For example, when a solid area fill includes multiple swath boundaries, horizontal bands may be visible. Swath height bands are caused by swath heights in excess of nominal (swath expansion) visualized as overlapping dots at the swath interface. Swath heights less than nominal (swath contraction) are visualized as having white line gaps between swaths. Horizontal bands are most easily seen when printing in the faster print modes, since the faster print modes are print modes with the least amount of shingling. Shingling is a technique used to mask such horizontal bands which would otherwise occur between swaths, wherein consecutive printing swaths are made to overlap and only a portion of the ink drops for a given print line, i.e., raster, are applied to the sheet of print media on a given pass of the printhead.

Another type of horizontal banding, referred to herein as intra-swath banding, occurs within a sub-swath height of a printhead. Intra-swath banding is primarily caused by systematic drop mass variations combined with systematic dot misdirection in the paper feed direction within a nozzle array formed on the printhead nozzle plate. Variations in drop mass within the nozzle array is visualized on the media as dot area variations on the sheet of print media, e.g., paper. If the dot area variations are somewhat random in nature, they would manifest themselves as bands, but at such a high spatial frequency as to be invisible to the human visual system. However, drop mass variations may occur from systematic causes, which often occur at spatial frequencies well within the frequency region that is readily perceived by the typical human eye.

It has now been recognized that one major cause of systematic drop mass variation in a printhead nozzle plate is a result of the technique used to form the nozzle openings in the nozzle plate, such as for example, through the use of laser ablation in forming the nozzle openings in a polyimide nozzle plate. For example, with a process potential of ±1 micron of exit opening diameter of a nozzle, systematic trends within the specification limits may produce dot area variations visible as intra-swath regions of light to dark transitions or bands.

What is needed in the art is a method of intra-swath banding compensation in an imaging apparatus.

### SUMMARY OF THE INVENTION

The present invention provides a method of intra-swath banding compensation in an imaging apparatus.

The invention, in one form thereof, is directed to a method of intra-swath banding compensation in an imaging apparatus utilizing an ink jet printhead that reciprocates in a main scan direction, the ink jet printhead having a nozzle array with a plurality of nozzles. The method includes printing with the plurality of nozzles in the main scan direction a pattern of dots representative of the nozzle array; determining a variation in reflectance of the pattern of dots in a direction substantially perpendicular to the main scan direction; and storing in a memory associated with the printhead compensation values associated with each nozzle of the plurality of nozzles that is to be adjusted to correct for the variation in reflectance.

The invention, in another form thereof, is directed to a method of intra-swath banding compensation in an imaging apparatus utilizing at least a first nozzle array and a second nozzle array, the first nozzle array and the second nozzle array having a plurality of nozzles. The method includes printing in a main scan direction a pattern of dots representative of the plurality of nozzles; determining a variation in reflectance of the pattern of dots in a direction substantially perpendicular to the main scan direction; and storing in a memory associated with the first nozzle array and the second nozzle array compensation values associated with each nozzle of the plurality of nozzles that is to be adjusted to correct for the variation in reflectance.

The invention, in still another form thereof, is directed to a printhead including a nozzle plate having a plurality of nozzles, and a memory. The memory stores compensation values associated with each nozzle of the plurality of nozzles that is to be adjusted to correct for a variation in reflectance values associated with an ink dot pattern printed with the plurality of nozzles from a nominal reflectance value.

### BRIEF DESCRIPTION OF THE DRAWINGS

The above-mentioned and other features and advantages of embodiments of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 is an exemplary depiction of the printhead of FIG. 1, with the printhead being projected over a sheet of print media.

FIG. 3 is an exemplary depiction of the reflectance sensor of FIG. 1, with the reflectance sensor being projected over a sheet of print media.

FIG. 4 is a flowchart depicting a method of intra-swath banding compensation, in accordance with an embodiment of the present invention.

FIG. 5A shows an exemplary pattern of dots used to collect reflectance data relating to a nozzle array of the printhead of FIG. 1.

FIG. 5B shows a pattern of dots that illustrates the reduction of intra-swath banding as a result of practicing a method of the present invention, in comparison to the pattern of dots of FIG. 5A.

FIG. 6A illustrates another pattern of dots that exhibits intra-swath banding.

FIG. 6B illustrates a pattern of dots exhibiting a reduction of intra-swath banding as a result of practicing a method of the present invention, in comparison to the pattern of dots of FIG. 6A.

FIG. 7A illustrates still another pattern of dots that exhibits intra-swath banding, with each block representing a different nozzle array.

FIG. 7B illustrates a pattern of dots exhibiting a reduction of intra-swath banding as a result of practicing a method of the present invention, in comparison to the pattern of dots of FIG. 7A.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF EMBODIMENTS OF THE INVENTION

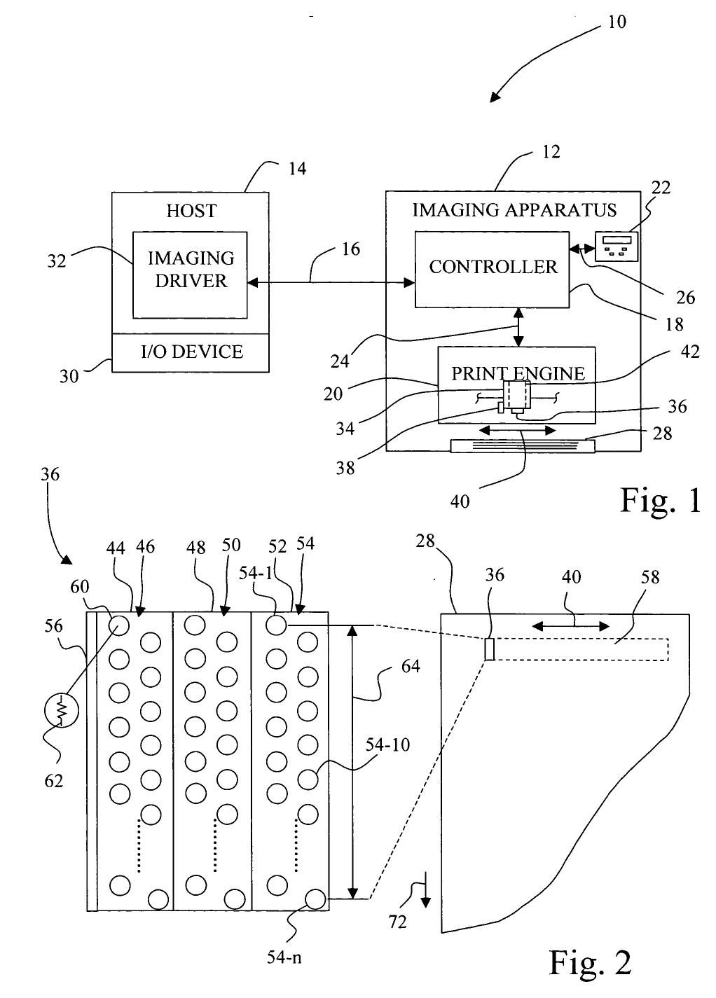

FIG. 1 is a diagrammatic depiction of a system 10 representing an embodiment of the present invention. System 10 may include an imaging apparatus 12 and a host 14, with imaging apparatus 12 communicating with host 14 via a communications link 16. Alternatively, imaging apparatus 12 may be a standalone unit that is not communicatively linked to a host, such as host 14. For example, imaging apparatus 12 may take the form of a multifunction machine that includes standalone copying and facsimile capabilities, in addition to optionally serving as a printer when attached to a host, such as host 14.

Imaging apparatus 12 may be, for example, an ink jet printer and/or copier. Imaging apparatus 12 includes, for example, a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26.

In the context of the examples for imaging apparatus 12 given above, print engine 20 may be, for example, an ink jet print engine configured for forming an image on a sheet of print media 28, such as a sheet of paper, transparency or fabric.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for imaging apparatus 12. Imaging driver 32 is in communication with controller 18 of imaging apparatus 12 via communications link 16. Imaging driver 32 facilitates communication between imaging apparatus 12 and host 14, and may provide formatted print data to imaging apparatus 12, and more particularly, to print engine 20.

Alternatively, however, all or a portion of imaging driver 32 may be located in controller 18 of imaging apparatus 12. For example, where imaging apparatus 12 is a multifunction machine having standalone capabilities, controller 18 of imaging apparatus 12 may include an imaging driver configured to support a copying function, and/or a fax-print function, and may be further configured to support a printer function. In this embodiment, the imaging driver facilitates communication of formatted print data, as determined by a selected print mode, to print engine 20.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

Print engine 20 may include, for example, a reciprocating printhead carrier 34, at least one ink jet printhead 36, and a reflectance sensor 38. Printhead carrier 34 transports ink jet printhead 36 and reflectance sensor 38 in a reciprocation manner in a bidirectional main scan direction 40 over an image surface of sheet of print media 28 during printing and/or sensing operations. Printhead carrier 34 may be mechanically and electrically configured to mount, carry and facilitate one or more printhead cartridges 42, such as a monochrome printhead cartridge and/or one or more color printhead cartridges. Each printhead cartridge 42 may include, for example, an ink reservoir containing a supply of ink, to which at least one respective printhead 36 is attached. In order for print data from host 14 to be properly printed by print engine 20, the rgb data generated by host 14 is converted into data compatible with print engine 20 and printhead 36.

In one system using cyan, magenta, yellow and black inks, printhead carrier 34 may carry four printheads, such as printhead 36, with each printhead carrying a nozzle array dedicated to a specific color of ink, e.g., cyan, magenta, yellow and black. As a further example, a single printhead, such as printhead 36, may include multiple ink jetting arrays, with each array associated with one color of a plurality of colors of ink, and printhead carrier 34 may be configured to carry multiple printheads.

FIG. 2 shows one exemplary configuration of printhead 36, which includes a cyan nozzle plate 44 including a nozzle array 46, a yellow nozzle plate 48 including a nozzle array 50, and a magenta nozzle plate 52 including a nozzle array 54, for respectively ejecting cyan (C) ink, yellow (Y) ink, and magenta (M) ink. In addition, printhead 36 may include a memory 56 for storing information relating to printhead 36 and/or imaging apparatus 12. For example, memory 56 may be formed integral with printhead 36, or may be attached to printhead cartridge 42. For convenience, and ease of discussion, memory 56 may also sometimes be referred to as printhead memory 56.

As further illustrated in FIG. 2, printhead carrier 34 is controlled by controller 18 to move printhead 36 in a reciprocating manner in main scan direction 40, with each left to right, or right to left movement of printhead carrier 34 along main scan direction 40 over the sheet of print media 28 being referred to herein as a pass. The area traced by printhead 36 over sheet of print media 28 for a given pass will be referred to herein as a swath, such as for example, swath 58 as shown in FIG. 2.

In the exemplary nozzle configuration for ink jet printhead 36 shown in FIG. 2, each of nozzle arrays 46, 50 and 54 include a plurality of ink jetting nozzles 60, with each ink jetting nozzle 60 having at least one corresponding heating element 62. As within a particular nozzle array, or as from one nozzle array in comparison to another, the nozzle sizes of the plurality of ink jetting nozzles may vary from a nominal nozzle size due to variations which occur during manufacture of the printhead nozzle plate, e.g., nozzle plates 44, 48, 52, respectively, that includes the respective nozzle array. For example, where nozzle plates 44, 48, 52 are formed from a polyimide or other plastic material, such variation in nozzle diameter may result from the technique used to form the nozzle openings in the nozzle plate, such as for example, through the use of laser ablation in forming the ink jetting nozzles 60 in the polyimide nozzle plate.

A swath height 64 of swath 58 corresponds to the distance between the uppermost and lowermost of the nozzles within an array of nozzles of printhead 36. In this example, the swath height 64 is the same for each of nozzle arrays 46, 50 and 54; however, this need not be the case, i.e., it is possible that the swath heights of nozzle arrays 46, 50 and 54 may be different, either by design or due to manufacturing tolerances.

Controller 18 may provide individual temperature control for each heating element 62, respectively, associated with ink jetting nozzles 60 of printhead 36. For example, each ink jetting nozzle 60 may be preheated to a respective predetermined temperature using a procedure called non-nucleating heating (NNH). NNH uses drop ejection pulse widths on a per nozzle basis to drive each individual heating element 62 to provide individual heater element temperature control. The per heater pulse widths are of such a short duration that a vapor bubble is not formed in the liquid ink, and no drop of ink is ejected from the corresponding ink jetting nozzle 60. The pulse of energy is of sufficient duration, however, to effectively heat the ink to a temperature that can be predetermined and correlated to the duration of the NNH energy pulse. By selecting the appropriate duration, frequency and/or quantity of the NNH energy pulse(s), the ejection temperature of the ink can be increased or decreased from a nominal value to compensate for insufficient or excessive drop mass, respectively, on a nozzle-by-nozzle basis. The change in drop mass as the ink ejection temperature changes, either increasing or decreasing from a nominal value, may be stored in memory 56 associated with printhead 36, such as for example, in the form of an equation or in the form of a lookup table (LUT).

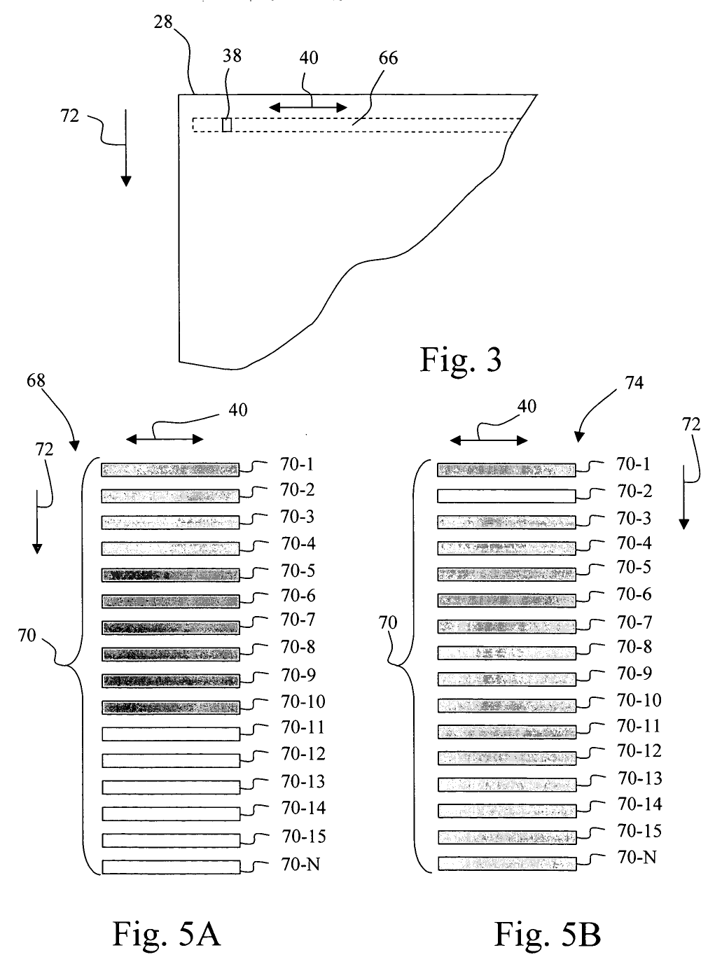

As further illustrated in FIG. 3, printhead carrier 34 is controlled by controller 18 to move reflectance sensor 38 in a reciprocating manner in main scan direction 40. The area traced by reflectance sensor 38 over sheet of print media 28 will be referred to herein as a sense path, such as for example, sense path 66. The height of sense path 66 may be substantially less than the height 64 of swath 58.

Reflectance sensor 38 is configured to provide reflectance data to controller 18 via communications link 24. Reflectance sensor 38 may be, for example, a unitary optical sensor including at least one light source, such as a light emitting diode (LED), and at least one reflectance detector, such as a phototransistor. The reflectance detector is located on the same side of the sheet of print media 28 as the light source. The operation of such sensors is well known in the art, and thus, will be discussed herein to the extent necessary to relate the operation of reflectance sensor 38 to the operation of the present invention. For example, the LED of reflectance sensor 38 directs light at a predefined angle onto a surface to be read, such as the surface of the sheet of print media 28, and at least a portion of light reflected from the surface is received by the reflectance detector of reflectance sensor 38. The intensity of the reflected light received by the reflectance detector varies with the reflectance, i.e., reflectivity, of the surface. The light received by the reflectance detector of reflectance sensor 38 is converted to an electrical signal by the reflectance detector of reflectance sensor 38, and is supplied to controller 18 for further processing. The signal generated by the reflectance detector corresponds to the reflectance of the surface scanned by reflectance sensor 38. Thus, as used herein, the term “reflectance” refers to the intensity of the light reflected from the sheet of print media 28 scanned by reflectance sensor 38, which may be used in accordance with the present invention in providing intra-swath banding compensation.

In accordance with the present invention, in one embodiment, an intra-swath reflectance map may be generated for printhead 36, and may be stored in memory, such as printhead memory 56, from which compensation values associated with individual heater elements may be derived and stored in memory, such as for example, printhead memory 56. The compensation values may relate, for example, to an ink ejection temperature, and in turn, to a drop mass of an ink drop expelled from a respective nozzle 60. Such an intra-swath reflectance map may be generated in accordance with the present invention, for example, via a test fixture (such as in the form of imaging apparatus 12) on the manufacturing line, or via imaging apparatus 12 at the time of printhead installation, e.g., installation of a new printhead, or during a user initiated re-mapping to improve print quality later in the life cycle of the printhead.

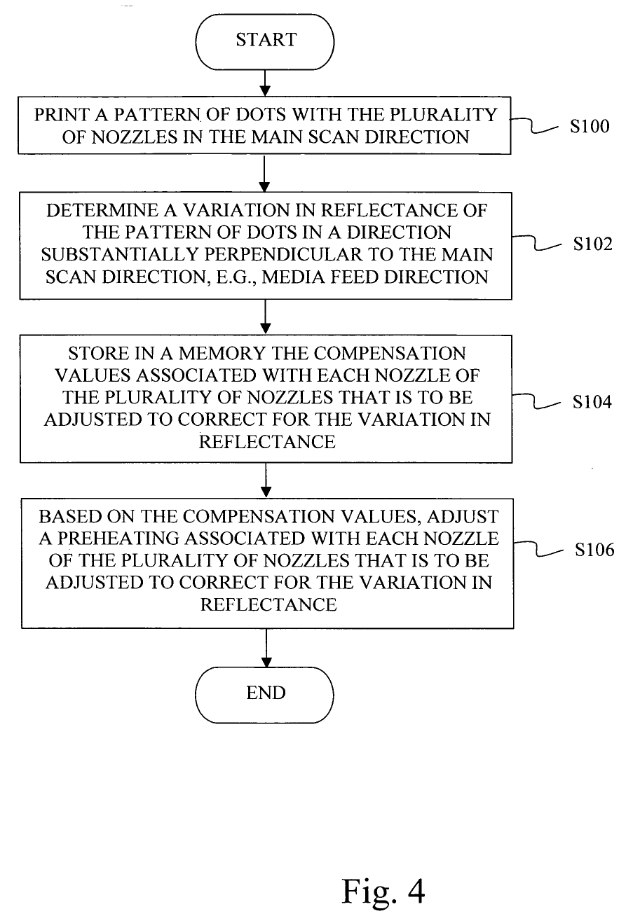

FIG. 4 is a flowchart of an exemplary method of intra-swath banding compensation in an imaging apparatus, in accordance with the present invention. The method of FIG. 4 will be described with respect to the exemplary pattern of dots of FIG. 5A.

At step S100, controller 18 commands the movement of printhead carrier 34 and printhead 36 to print with the plurality of nozzles 60 in main scan direction 40 a pattern of dots, such as pattern of dots 68 shown in FIG. 5A, representative of the corresponding nozzle array, e.g., one of nozzle arrays 46, 50, 54. In the example that follows, nozzle array 54 will be used for illustrative purposes.

As shown in FIG. 5A, for example, pattern of dots 68 is generated forming a series of rectangular blocks 70, individually labeled 70-1 through 70-N, each being formed by a subset of the total of nozzles 60 of nozzle array 54 of printhead 36. For example, each of rectangular blocks 70 may be formed by ten to twenty consecutive nozzles within nozzle array 54, and may be one hundred to two hundred pels in length in main scan direction 40. As a more specific example, assume nozzle array 54 includes a total of 160 nozzles, and it is determined that pattern of dots 68 will include 16 rectangular blocks, then rectangular block 70-1 will be formed by the 10 consecutive nozzles 54-1 through 54-10; rectangular block 70-2 will be formed by the next 10 consecutive nozzles 54-11 through 54-20; rectangular block 70-3 will be formed by the next 10 consecutive nozzles 54-21 through 54-30; and so on, until all of rectangular blocks 70 are printed.

In pattern of dots 68, for example, in order to provide a separation between vertically adjacent blocks, the sheet of print media 28 is advanced in the media feed direction 72 between the printing of each of rectangular blocks 70-1 through 70-N, with each rectangular block being printed on a separate pass of printhead 36. Thus, the swath height of nozzle array 54 is effectively doubled to aid in the sensing of the respective reflectance associated with each of rectangular blocks 70.

At step S102, a variation in reflectance of the pattern of dots in a direction substantially perpendicular to main scan direction 40, e.g., media feed direction 72, is determined. With respect to FIG. 5A, for example, the reflectance of the pattern of dots 68 is read by reflectance sensor 38 by scanning reflectance sensor 38 over each block of the rectangular blocks 70, from which the reflectance data is retrieved and stored in memory, such as for example, in memory 56. Alternatively, reflectance sensor 38 may be held stationary, and the pattern of dots 68 may be scanned in media feed direction 72 relative to reflectance sensor 38. The reflectance data may then be compared to a nominal reflectance value. A reflectance map is then generated which includes compensation values based on a variation in reflectance exhibited by the reflectance data from the nominal reflectance value.

As can be recognized from the pattern of dots 68 formed by rectangular blocks 70, for example, the individual blocks vary in printed density, and thus vary in reflectance when sensed by reflectance sensor 38, from one block to another. For example, rectangular blocks 70-1 through 70-10 are relatively dark in comparison to rectangular blocks 70-11 through 70-N, and thus will be relatively lower in reflectance; rectangular block 70-1 may be slightly lighter than rectangular block 70-2 and thus will be relatively higher in reflectance; and so on.

At step S104, the compensation values associated with each nozzle of plurality of nozzles that is to be adjusted to correct for the variation in reflectance is stored in a memory, such as memory 56 associated with printhead 36.

In one embodiment, for example, the average reflectance level of each block of rectangular blocks 70 is recorded, e.g., stored in memory 56, and a mapping of the variation in reflectance from block to block associated with the nozzle array of the printhead is quantified and stored in printhead memory 56. This may be repeated for each nozzle array of printhead 36, e.g., for each color C, Y, M of corresponding nozzle arrays 46, 50, and 54. This may also be repeated for other printheads carried by printhead carrier 34.

For example, if the top to bottom variation from rectangular block 70-1 to rectangular block 70-N is within predetermined limits, then no temperature compensation is required, and a compensation value of zero would be associated with each nozzle 60. However, if any of the rectangular blocks exhibit a variation in reflectance, as would be the case with the pattern of dots 68 of FIG. 5A, either higher or lower than a nominal reflectance value, then for the subset of nozzles 60 associated with that particular block of the rectangular blocks 70, a compensation value is derived so that the nozzles will be jetted at a compensatingly higher or lower temperature (controlled by NNH inputs), to increase or decrease the ejected drop mass respectively.

At step S106, based on the compensation values, a preheating associated with each nozzle of said plurality of nozzles that is to be adjusted to correct for the variation in reflectance is adjusted. For example, a subset of nozzles corresponding to a particular rectangular block of dots that exhibits nominal reflectance values may be mapped via a respective compensation value to a temperature, such as in a temperature lookup table (LUT) stored in memory 56, with a nominal value of ejection temperature. A subset of nozzles corresponding to a particular rectangular block of dots that exhibits lower reflectance values from nominal may be mapped via a respective compensation value to a temperature, such as in the temperature LUT stored in memory 56, to a region of the LUT with predetermined lower ink ejection temperatures than nominal. Likewise, a subset of nozzles corresponding to a particular rectangular block of dots that exhibits reflectance values higher than nominal reflectance values may be mapped via a respective compensation value to a temperature, such as in the temperature LUT stored in memory 56, to a region of the LUT with higher ink ejection temperatures. Thereafter, the non-nucleating heating (NNH) for each heating element 62 may be adjusted in accordance with the mapping. For example, the preheating may be in the form of a respective non-nucleating heating pulse, which is applied to a respective heating element 62 to adjust a drop mass of an ink drop expelled by a respective nozzle.

FIG. 5B shows a pattern of dots 74 that illustrates the reduction of intra-swath banding as a result of practicing a method of the present invention, in comparison to the pattern of dots 68 of FIG. 5A. As illustrated, after reflectance mapping the nozzle array, systematic variations in ablated nozzle plate exit diameter will be thermally compensated for, so that ejected drop mass will be uniform across the nozzle array. Uniformity in ejected drop mass will reduce intra-swath banding to levels unnoticeable by the average observer. Thus, as shown, after compensation, the rectangular blocks 70-1 through 70-N are relatively uniform in printed density.

While a method of the present invention was described above with respect to the exemplary dot patterns of FIGS. 5A and 5B, those skilled in the art will recognize that other dot patterns may be used in collecting reflectance data.

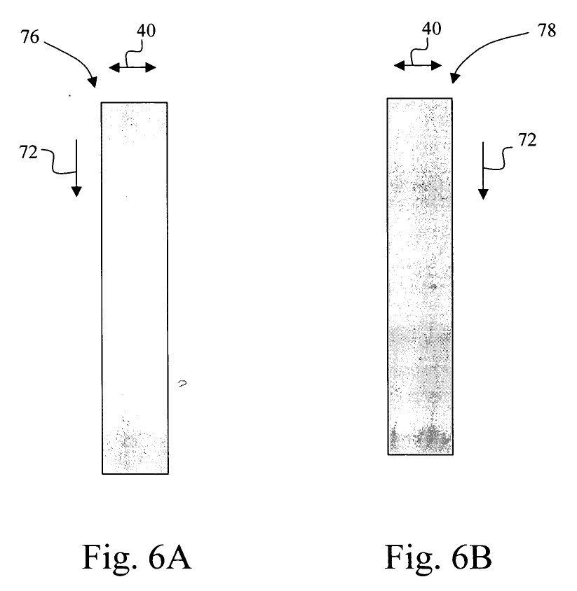

For example, each of FIGS. 6A and 6B illustrate a single block of dots printed. FIG. 6A illustrates a pattern of dots 76 exhibiting intra-swath banding, prior to using a method of intra-swath banding compensation in accordance with the present invention. As shown, the pattern of dots 76 is a relatively continuous block, which may correspond to a height of the respective nozzle array. This example differs for that of FIGS. 5A, 5B, in that the height of the sense path 66 of reflectance sensor 38 is correlated to a subset of nozzles of the nozzle array used to generate a respective portion of the pattern of dots 76, since individual rectangular blocks associated with a particular subset of nozzles are not formed. FIG. 6B illustrates a pattern of dots 78 exhibiting a reduction of intra-swath banding as a result of practicing a method of the present invention, in comparison to the pattern of dots 76 of FIG. 6A.

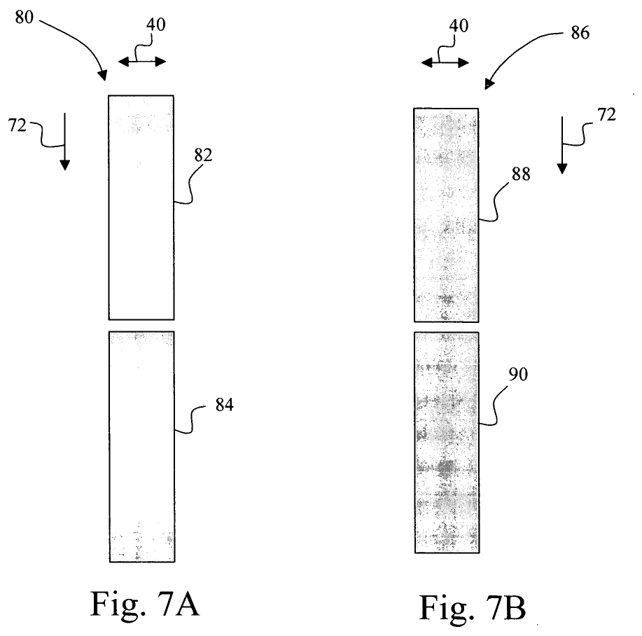

FIGS. 7A and 7B illustrate two single blocks of dots, with a particular single block associated with a particular array of nozzles. For example, some printheads may have two or more nozzle arrays, which may be vertically arranged, such as for example, in media feed direction 72. Alternatively, two or more printheads, each having at least one array of nozzles, may be vertically offset in media feed direction 72, and/or horizontally offset. In this example, the pattern of dots 80 includes a rectangular block of dots 82 corresponding, for example, to an upper array of nozzles, and a rectangular block of dots 84 corresponding, for example, to a lower or intermediate array of nozzles, with each of the blocks of dots 82, 84 being printed in one or more passes. In sensing the pattern of dots 80, the height of the sense path 66 of reflectance sensor 38 is correlated to a subset of nozzles of the nozzle array used to generate a respective portion of the pattern of dots 80. FIG. 7B illustrates a pattern of dots 86, including rectangular blocks of dots 88, 90, exhibiting a reduction of intra-swath banding as a result of practicing a method of the present invention, in comparison to the pattern of dots 80 of FIG. 7A.

While this invention has been described with respect to exemplary embodiments of the present invention, those skilled in the art will recognize that the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of intra-swath banding compensation in an imaging apparatus utilizing an ink jet printhead that reciprocates in a main scan direction, said ink jet printhead having a nozzle array with a plurality of nozzles, said method comprising:
printing with said plurality of nozzles in said main scan direction a pattern of dots representative of said nozzle array;
determining a variation in reflectance of said pattern of dots in a direction substantially perpendicular to said main scan direction; and
storing in a memory associated with said printhead compensation values associated with each nozzle of said plurality of nozzles that is to be adjusted to correct for said variation in reflectance.

2. The method of claim 1, wherein the act of determining comprises:
generating reflectance data associated with said nozzle array based on said pattern of dots;
comparing said reflectance data to a nominal reflectance value; and generating a reflectance map including said compensation values based on said variation in reflectance exhibited by said reflectance data from said nominal reflectance value.

3. The method of claim 1, further comprising adjusting, based on said compensation values, a preheating associated with each nozzle of said plurality of nozzles that is to be adjusted to correct for said variation in reflectance.

4. The method of claim 3, wherein each nozzle of said plurality of nozzles includes a respective heater element, said preheating being a respective non-nucleating pulse or pulses applied to said respective heater element to adjust a drop mass of an ink drop expelled by a respective nozzle.

5. The method of claim 1, wherein said method is performed each time a new printhead is installed in said imaging apparatus.

6. The method of claim 1, wherein said method is performed each time said printhead is reinstalled in said imaging apparatus.

7. The method of claim 1, wherein said imaging apparatus is a test fixture, and wherein said method is performed at a time of manufacture of a printhead cartridge utilizing said ink jet printhead.

8. The method of claim 1, wherein said method is repeated after a period of use of said ink jet printhead.

9. The method of claim 1, wherein said pattern of dots is a plurality of vertically spaced blocks of dots.

10. The method of claim 1, wherein said pattern of dots is a relatively continuous block corresponding to a height of said nozzle array.

11. A method of intra-swath banding compensation in an imaging apparatus utilizing at least a first nozzle array and a second nozzle array, said first nozzle array and said second nozzle array having a plurality of nozzles, said method comprising:
printing in a main scan direction a pattern of dots representative of said plurality of nozzles;
determining a variation in reflectance of said pattern of dots in a direction substantially perpendicular to said main scan direction; and
storing in a memory associated with said first nozzle array and said second nozzle array compensation values associated with each nozzle of said plurality of nozzles that is to be adjusted to correct for said variation in reflectance.

12. The method of claim 11, wherein the act of determining comprises:
generating reflectance data associated with said pattern of dots;
comparing said reflectance data to a nominal reflectance value; and
generating a reflectance map including said compensation values based on said variation in reflectance exhibited by said reflectance data from said nominal reflectance value.

13. The method of claim 11, further comprising adjusting, based on said compensation values, a preheating associated with each nozzle of said plurality of nozzles that is to be adjusted to correct for said variation in reflectance.

14. The method of claim 13, wherein each nozzle of said plurality of nozzles includes a respective heater element, said preheating being a respective non-nucleating pulse or pulses applied to said respective heater element to adjust a drop mass of an ink drop expelled by a respective nozzle.

15. The method of claim 11, wherein said method is performed each time a new printhead is installed in said imaging apparatus.

16. A printhead, comprising:
a nozzle plate having a plurality of nozzles; and
a memory that stores compensation values associated with each nozzle of said plurality of nozzles that is to be adjusted to correct for a variation in reflectance values associated with an ink dot pattern printed with said plurality of nozzles from a nominal reflectance value.
